(19) United States
(12) Patent Application Publication
(10) Pub. No.: US 2025/0260591 A1
(43) Pub. Date: Aug. 14, 2025

(54) HANDLING OF FAILED OR PRE-EMPTED MBS BROADCAST SESSIONS

(71) Applicant: Nokia Technologies Oy, Espoo (FI)

(72) Inventors: Philippe GODIN, Massy (FR); Bruno LANDAIS, Lannion (FR); Horst Thomas BELLING, Munich (DE); Ugur Baran ELMALI, Munich (DE); David NAVRÁTIL, Espoo (FI); Bighnaraj PANIGRAHI, Bangalore (IN)

(21) Appl. No.: 18/996,129

(22) PCT Filed: Jul. 18, 2023
(86) PCT No.: PCT/IB2023/057332

§ 371 Date: Jan. 17, 2025

(30) Foreign Application Priority Data
Jul. 18, 2022 (IN) 202211040865

(51) Int. Cl. H04L 12/18; H04W 4/06

(52) U.S. Cl. CPC H04L 12/1868; H04L 12/189; H04W 4/06

(57) ABSTRACT

An apparatus of a multicast/broadcast control element is provided, which comprises at least one processor and at least one memory including computer program code, the at least one memory and the computer program code configured to, with the at least one processor, cause the apparatus at least to perform: initiating a multicast/broadcast session by sending a request for allocating resources for the multicast/broadcast session to at least one radio access network node, receiving an error message from at least one radio access network node that the resources cannot be allocated and/or cannot be maintained, and re-sending a request for allocating resources for the multicast/broadcast session to the at least one radio access network node having sent the failure message after elapse of a predetermined time.

### REFERENCE TO RELATED APPLICATIONS

This patent application claims the benefit of priority of Indian Patent Application No. 202211040865 filed Jul. 18, 2022, which is hereby incorporated by reference as if reproduced in its entirety.

### FIELD OF THE INVENTION

The present invention relates to an apparatus, a method and a computer program product for handling of failed or pre-empted MBS broadcast sessions.

### RELATED BACKGROUND ART

The following meanings for the abbreviations used in this specification apply:
AMF Access management function
DL Downlink
DSP Digital signal processor
MBS Multicast/broadcast services
MB-SMF Multicast broadcast session management function
MB-UPF Multicast broadcast user plane function
MCCH Multicast control channel
MTCH Multicast transport channel
NGAP New Generation Application Protocol
QoS Quality of Service
RAN Radio access network
TNL Tunnel
UE User equipment

Example embodiments, although not limited to this, relate to multicast and broadcast session. In particular, in release 17, two types of MBS sessions can be set up, namely broadcast sessions and multicast sessions.

In broadcast sessions the MBS data is delivered over a service area which may comprise several RAN nodes. At broadcast session start, an MB-SMF sends a Broadcast session start message including an MBS service area towards an AMF. The AMF analyses the MBS service area and sends an NGAP Broadcast session setup message to all RAN nodes involved in the service area. The RAN nodes perform admission control, and if enough resources are present, start to deliver the broadcast data over the air.

It may happen that later on, the resource situation evolves and the RAN nodes have not enough resources for all MBS sessions and need to pre-empt one broadcast session of low priority. Therefore, an NGAP Broadcast release required message has been introduced that RAN node can send to AMF to request the release of the broadcast session.

Upon receiving the NGAP Broadcast release required message the AMF generates a NG Broadcast release request message to RAN node asking to release the broadcast session. Upon receiving this NG Broadcast release request message the RAN node releases the resources associated to this broadcast session and replies with NG Broadcast release response message. The NG broadcast release response message is sent to AMF and AMF informs MB-SMF including the N2 container using Namf_MBSBroadcast__ContextStatusNotify service operation.

However, even when the situation should improve later, the RAN node would not be able to support or join the MBS broadcast session.

### SUMMARY OF THE INVENTION

Example embodiments address this situation and aim to provide measures for improving handling of MBS sessions in case a RAN node cannot set up or cannot maintain the resources of an MBS session.

According to a first aspect, an apparatus of a multicast/broadcast control element, is provided, the apparatus comprising: at least one processor and at least one memory including computer program code, the at least one memory and the computer program code configured to, with the at least one processor, cause the apparatus at least to perform: initiating a multicast/broadcast session by sending a request for allocating resources for the multicast/broadcast session to at least one radio access network node, receiving an error message from at least one radio access network node that the resources cannot be allocated and/or cannot be maintained, and re-sending a request for allocating resources for the multicast/broadcast session to the at least one radio access network node having sent the failure message after elapse of a predetermined time.

According to a second aspect, a method for use in a multicast/broadcast control element, is provided, the method comprising:
initiating a multicast/broadcast session by sending a request for allocating resources for the multicast/broadcast session to at least one radio access network node,
receiving an error message from at least one radio access network node that the resources cannot be allocated and/or cannot be maintained, and
re-sending a request for allocating resources for the multicast/broadcast session to the at least one radio access network node having sent the failure message after elapse of a predetermined time.

The first and second aspects may be modified as follows:

The predetermined time may be preset (predetermined, predefined) by an internal timer of the apparatus or multicast/broadcast control element.

With the error message, timer information may be received from the at least one radio access network node, the timer information defining the predetermined time.

Information concerning the multicast/broadcast session may be stored.

Any update received of the previously stored information concerning the multicast/broadcast session may be stored, and the latest updated information may be used for resending retrying to initiate the multicast/broadcast session after elapse of the predetermined time.

The multicast/broadcast control element may be or may be part of an access management function, and information concerning the multicast/broadcast session may be received from a multicast broadcast session management function.

The multicast/broadcast control element may be or may be part of a multicast broadcast session management function, and the timer information may be received from the at least one radio access network node via an access management function, and the request for allocation resources for the multicast/broadcast session may be re-sent after expiry of the predetermined time via the access management function.

Before re-sending the request for allocating resources for the multicast/broadcast session to the at least one radio access network node, it may be determined whether the least one radio access network node is in a service area specified for the multicast/broadcast session.

According to a third aspect, an apparatus (for example of a radio access network node) is provided, the apparatus comprising: at least one processor and at least one memory including computer program code, the at least one memory and the computer program code configured to, with the at least one processor, cause the apparatus at least to perform: receiving a request for allocating resources for a multicast/broadcast session from a multicast/broadcast control element, in case resources cannot be allocated and/or resources have to be released during the multicast/broadcast session, sending an error message to the multicast/broadcast control element indicating that the resources cannot be allocated and/or cannot be maintained, and in response to receiving a further request for allocating resources for the multicast/broadcast session, re-trying to allocate resources.

According to a fourth aspect, a method (for example of a radio access network node) is provided, the method comprising:
receiving a request for allocating resources for a multicast/broadcast session from a multicast/broadcast control element,
in case resources cannot be allocated and/or resources have to be released during the multicast/broadcast session, sending an error message to the multicast/broadcast control element indicating that the resources cannot be allocated and/or cannot be maintained, and
in response to receiving a further request for allocating resources for the multicast/broadcast session, re-trying to allocate resources.

The third and fourth aspects may be modified as follows:

27. The method according to claim 26, further comprising:

Timer information may be included into the error message, the timer information indicating a time after which the multicast/broadcast session can be initiated again.

The timer information may be based on congestion experienced by the apparatus (for example the radio access network node).

The error message including the timer information may be sent to an access management function.

The timer information may be incorporated in an information element to be forwarded to a multicast broadcast session management function via an access management function.

According to a fifth aspect, an apparatus (for example of a radio access network node) is provided, the apparatus comprising: at least one processor and at least one memory including computer program code, the at least one memory and the computer program code configured to, with the at least one processor, cause the apparatus at least to perform: receiving a request for allocating resources for a multicast/broadcast session from a multicast/broadcast control element, successfully allocating the resources, in case resources cannot be maintained at least temporarily during the multicast/broadcast session, suspending the multicast/broadcast session, continuing storing any updates concerning the multicast/broadcast session received from a multicast broadcast session management function, and when resources become available again, resuming the multicast/broadcast session.

According to a sixth aspect, a method (for example for use in a radio access network node) is provided, the method, comprising:
receiving a request for allocating resources for a multicast/broadcast session from a multicast/broadcast control element, successfully allocating the resources,
in case resources cannot be maintained at least temporarily during the multicast/broadcast session, suspending the multicast/broadcast session,
continuing storing any updates concerning the multicast/broadcast session received from a multicast broadcast session management function, and
when resources become available again, resuming the multicast/broadcast session.

The fifth and sixth aspects may be modified as follows:

The multicast/broadcast session may be suspended by leaving a transport network multicast and updating a multicast control channel, and the multicast/broadcast session may be resumed by joining the transport network multicast and updating the multicast control channel.

The multicast/broadcast session may be suspended by sending a session suspend request to the multicast broadcast session management function via an access management function and updating a multicast control channel, and the multicast/broadcast session may be resumed by sending a session resume request to the multicast broadcast session management function via the access management function and updating the multicast control channel.

According to a seventh aspect, an apparatus of a multicast broadcast session management function is provided, the apparatus comprising: at least one processor and at least one memory including computer program code, the at least one memory and the computer program code configured to, with the at least one processor, cause the apparatus at least to perform: receiving a session suspend request from a radio access network node requesting to suspend the delivery for a multicast/broadcast session, and updating the session by removing a downlink tunnel at a multicast broadcast user plane function for the multicast/broadcast session to the radio access network node, sending updates concerning the multicast/broadcast session to the RAN node, and receiving a session resume request from the radio access network, and updating the session by adding the downlink tunnel at a multicast broadcast user plane function.

According to an eighth aspect, a method for use in a multicast broadcast session management function is provided, the method comprising:
receiving a session suspend request from a radio access network node requesting to suspend the delivery for a multicast/broadcast session, and
updating the session by removing a downlink tunnel at a multicast broadcast user plane function for the multicast/broadcast session to the radio access network node,
sending updates concerning the multicast/broadcast session to the RAN node, and
receiving a session resume request from the radio access network, and
updating the session by adding the downlink tunnel at a multicast broadcast user plane function.

According to a ninth aspect of the present invention a computer program product is provided which comprises code means for performing a method according to any one of the second, fourth, sixth and eighth aspects and/or their modifications when run on a processing means or module. The computer program product may be embodied on a computer-readable medium, and/or the computer program product may be directly loadable into the internal memory of the computer and/or transmittable via a network by means of at least one of upload, download and push procedures.

According to a tenth aspect, an apparatus is provided which comprises:
means for initiating a multicast/broadcast session by sending a request for allocating resources for the multicast/broadcast session to at least one radio access network node,
means for receiving an error message from at least one radio access network node that the resources cannot be allocated and/or cannot be maintained, and
means for re-sending a request for allocating resources for the multicast/broadcast session to the at least one radio access network node having sent the failure message after elapse of a predetermined time.

According to a eleventh aspect, an apparatus is provided which comprises:
means for receiving a request for allocating resources for a multicast/broadcast session from a multicast/broadcast control element,
means for sending an error message to the multicast/broadcast control element indicating that the resources cannot be allocated and/or cannot be maintained, in case resources cannot be allocated and/or resources have to be released during the multicast/broadcast session, and
means for re-trying to allocate resources in response to receiving a further request for allocating resources for the multicast/broadcast session.

According to a twelfth aspect, an apparatus is provided which comprises:
means for receiving a request for allocating resources for a multicast/broadcast session from a multicast/broadcast control element,
means for successfully allocating the resources,
means for suspending the multicast/broadcast session in case resources cannot be maintained at least temporarily during the multicast/broadcast session,
means for continuing storing any updates concerning the multicast/broadcast session received from a multicast broadcast session management function, and
means for resuming the multicast/broadcast session when resources become available again.

According to a thirteenth aspect, an apparatus is provided which comprises:
means for receiving a session suspend request from a radio access network node requesting to suspend the delivery for a multicast/broadcast session, and
means for updating the session by removing a downlink tunnel at a multicast broadcast user plane function for the multicast/broadcast session to the radio access network node,
means for sending updates concerning the multicast/broadcast session to the radio access network node, and
means for receiving a session resume request from the radio access network, and
means for updating the session by adding the downlink tunnel at a multicast broadcast user plane function.

### BRIEF DESCRIPTION OF THE DRAWINGS

These and other objects, features, details and advantages will become more fully apparent from the following detailed description of example embodiments, which is to be taken in conjunction with the appended drawings, in which:

FIG. 1A shows a multicast/broadcast control element 1 according to an example embodiment,

FIG. 1B shows a procedure carried out by the multicast/broadcast control element 1 according to the example embodiment,

FIG. 2A shows a RAN node 2 according to an example embodiment,

FIG. 2B shows a procedure carried out by the RAN node 2 according to the example embodiment,

FIG. 3A shows an alternative procedure carried out by the RAN node according to an example embodiment,

FIG. 3B shows an alternative procedure carried out by the multicast/broadcast control element 1 being a multicast broadcast session management function according to an example embodiment,

FIG. 4 shows a signal flow according to a first embodiment,

FIGS. 5 and 6 show signal flows according to a second embodiment,

FIGS. 7 to 9 show signal flows according to a third embodiment,

FIGS. 10 and 11 shows signal flows according to a fourth embodiment,

FIG. 12 shows a broadcast session setup, unsuccessful operation, according to a further embodiment, and

FIG. 13 shows broadcast session release required, successful operation, according to a further embodiment.

### DETAILED DESCRIPTION OF EXAMPLE EMBODIMENTS

In the following, description will be made to example embodiments. It is to be understood, however, that the description is given by way of example only, and that the described example embodiments are by no means to be understood as limiting the present invention thereto.

Before describing example embodiment, in the following, problems of the prior art are discussed in some more detail.

During admission control in the RAN of a broadcast session, admission control may not totally succeed in some gNBs due to congestion of resources resulting in:
A RAN node (e.g. gNB) may need to fail the setup of the broadcast session.
A RAN node (e.g. gNB) may need to pre-empt the resources of a lower priority broadcast session.

If the resource situation improves in the RAN node, there is currently no solution how the broadcast session can be restored in this RAN node.

For example, the RAN node has no visibility of what happened to the broadcast session after the failure or the pre-emption, for instance the broadcast session may even be ended. It therefore makes little sense to enable the RAN node to blindly request AMF or MB-SMF to be added again to the broadcast session, because this session may be over since some time. This would be a waste of signalling.

The problem is therefore how to restore a broadcast session in a RAN node after this RAN node has failed the admission control of this broadcast session due to congested resources, or has pre-empted an already started broadcast session due to lack of resources, once the congestion situation has been resolved.

The Broadcast Release Required procedure as mentioned above is a Class2 NGAP procedure using non-UE associated signalling. The purpose of Broadcast Session Release Required message is to trigger the CN initiating Broadcast Session Release procedure. Upon reception of the Broadcast Session Release Required message, the CN shall realize there is no adequate resources for RAN to provide the broadcast service over radio and initiate the Broadcast Session Release procedure to release the MBS context corresponding to the previous established MBS session.

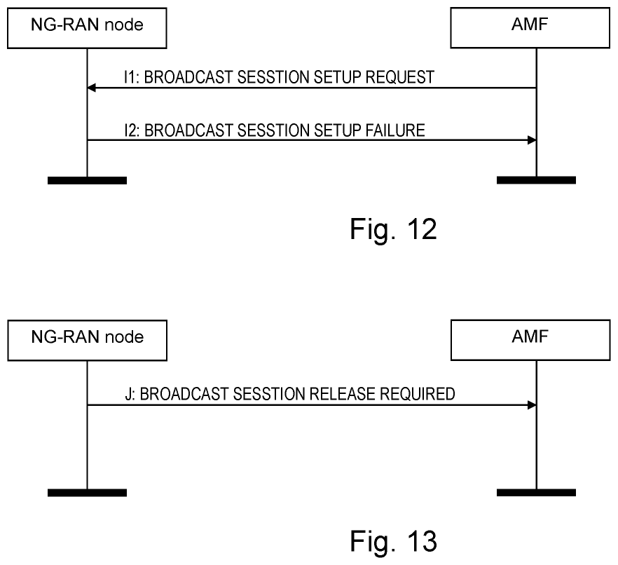

The broadcast session release required message is illustrated in FIG. 13, for example.

Example embodiments are directed to provide an improved handling of MBS sessions in case a RAN node cannot set up or maintain an MBS session, since, for example, the RAN node has to release resources.

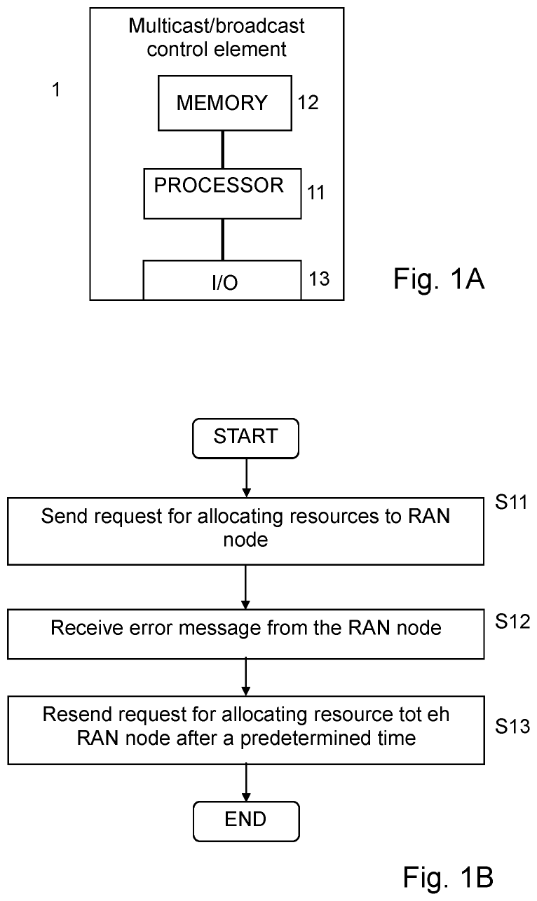

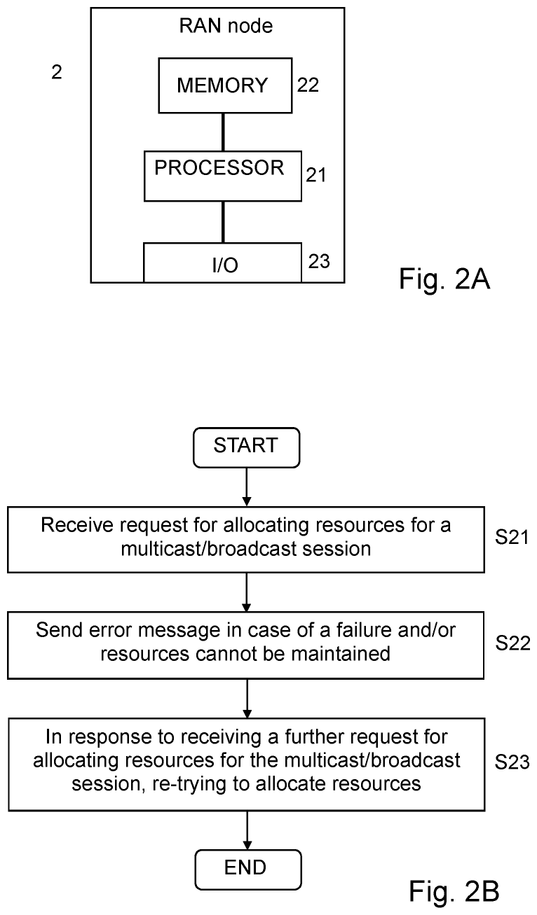

In the following, a general overview of some example embodiments is described by referring to FIGS. 1A, 1B, 2A and 2B.

FIG. 1A shows a multicast/broadcast control element 1 as an example for a first apparatus according to the present example embodiment. The first apparatus may be the multicast/broadcast control element, or may be a part thereof. For example, the multicast/broadcast control element may be an access management function (AMF) or a multicast broadcast session management function (MB-SMF). A procedure carried out by the multicast/broadcast control element 1 is illustrated in FIG. 1B.

The multicast/broadcast control element 1 shown in FIG. 1A comprises at least one processor 11 and at least one memory 12 including computer program code. The at least one processor 11, with the at least one memory 12 and the computer program code, is configured to cause the apparatus to perform: initiating a multicast/broadcast session by sending a request for allocating resources for the multicast/broadcast session to at least one radio access network node (e.g., RAN node 1 shown in FIG. 1B) (S11), receiving an error message from at least one radio access network node that the resources cannot be allocated and/or cannot be maintained (S12), and re-sending a request for allocating resources for the multicast/broadcast session to the at least one radio access network node having sent the failure message after a predetermined time (S13).

FIG. 2A shows a radio access network node (RAN node) 2 as an example for a second apparatus according to the present example embodiment. The second apparatus may be the RAN node, or may be a part thereof. Moreover, the RAN node may be a gNB. A procedure carried out by the RAN node 2 is illustrated in FIG. 2B.

The RAN node 2 shown in FIG. 2A comprises at least one processor 21 and at least one memory 22 including computer program code. The at least one processor 21, with the at least one memory 22 and the computer program code, is configured to cause the apparatus to perform: receiving a request for allocating resources for a multicast/broadcast session from a multicast/broadcast control element (e.g., shown in FIG. 1A) (S21), in case resources cannot be allocated and/or resources have to be released during the multicast/broadcast session, sending an error message to the multicast/broadcast control element indicating that the resources cannot be allocated and/or cannot be maintained (S22), and, in response to receiving a further request for allocating resources for the multicast/broadcast session, re-trying to allocate resources (S23).

The apparatuses 1 and 2 described above may further comprise I/O units 13, 23, which are capable of transmitting to and receiving from other network elements.

Thus, according to some example embodiments as described above, it is possible to trigger a retry of allocating resources to a multicast/broadcast session.

This retry may be triggered by the AMF or the MB-SMF after a predetermined time. This predetermined time may be preset by an internal timer of the AMF or the MB-SMF. However, the predetermined time may also be determined by the RAN node, for example based on congestion experienced by the RAN node. Then, the retry, i.e., re-sending of the request for allocating resource, will not take place before elapse of the predetermined time.

The predetermined time as determined by the RAN node may be referred to as timer information, and according to some embodiments, this is referred to as “wait timer before retry” or “wait timer”, and may be an information element (IE) inserted in a suitable message.

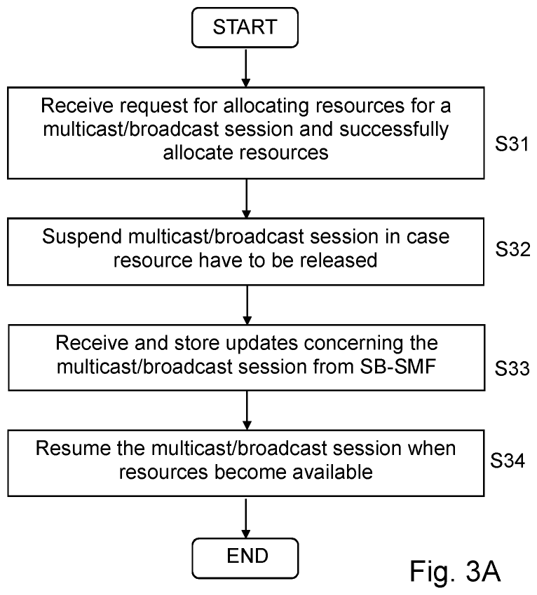

A further exemplar embodiment is described in the following by referring to FIGS. 3A and 3B.

FIG. 3A shows an alternative procedure carried out by the RAN node 2. In S31, the RAN node 2 receives a request for allocating resources for a multicast/broadcast session from a multicast/broadcast control element and successfully allocates the resources. In S32, in case resources have to be released e.g. pre-empted for at least a temporary time during the multicast/broadcast session, the multicast/broadcast session is suspended. In S33, the RAN node 2 continues storing any updates concerning the multicast/broadcast session received from a multicast broadcast session management function and takes these updates into account even though the session is suspended, and then, when resources become available again, the RAN node resumes the multicast/broadcast session in S34.

FIG. 3B shows an alternative procedure carried out by the multicast/broadcast control element 1 being a multicast broadcast session management function. In S41, the multicast/broadcast control element 1 receives a session suspend request from a radio access network node requesting to suspend delivery for a multicast/broadcast session, and, in S42, updates the session by removing a downlink tunnel at a multicast broadcast user plane function (MB-UPF) for the multicast/broadcast session to the radio access network node, and thus the delivery of session's data to the radio access network node is stopped. In S43, the multicast/broadcast control element 1 continues sending updates concerning the multicast/broadcast session to the RAN node despite the suspended state. In S44, the multicast/broadcast control element 1 receives a session resume request from the radio access network, and, in S45, updates the session by adding the downlink tunnel at a multicast broadcast user plane function, and thus the delivery of session's data to the radio access network node is resumed.

Thus, according to the example embodiments described above in connection with FIGS. 3A and 3B, if necessary, a RAN node can easily suspend a MBS session and resume it again later, when resources are available again.

The above procedures are described in the following by referring to some further detailed embodiments.

### First Embodiment

According to a first embodiment, blind try and failure is triggered by AMF or MB-SMF

First, a pre-empted session is described. That is, the RAN node pre-empts a broadcast session due to lack of resources and sends broadcast release required message to AMF to notify the request to release.

Option 1: retry triggered by the AMF: after receiving the NG Broadcast Release Required message, the AMF keeps the MBS session context as long as the MBS session exists. It stores any updates of the N2 container and service area received from the MB-SMF. As long as the AMF sees that the RAN node is still part of the service area, the AMF may blindly retry from time to time to send an NG Session Setup message towards the RAN node. The RAN node then runs admission control and if the congestion has disappeared starts again to deliver the broadcast data.

Option 2: retry triggered by the MB-SMF: after receiving the NG Broadcast Release Response Transfer container (N2 container) within the Namf_MBSBroadcast__ContextStatusNotify request message, the MB-SMF keeps the MBS session context as long as the MBS session exists. The MB-SMF may retry from time to time to send an Broadcast Session Update or Setup message towards the AMF including this RAN node ID. If The AMF may then check if the RAN node is in the latest received service area, and if this is the case the AMF can send an NG Broadcast session setup to the RAN node to start again the session. The RAN node runs admission control and if the congestion has disappeared starts again to deliver the broadcast data.

Failed setup session: RAN node fails the broadcast session setup due to lack of resources.

The handling for this failed session setup case can be deduced from the pre-empted session case by replacing the messages used by RAN to notify the CN:
For option 1: “NG broadcast Release Required” replaced by “NG broadcast session setup failure”.
For option 2: “NG broadcast release response transfer” replaced by “NG broadcast setup failure transfer”.

In the following, the first embodiment is described in some more detail.

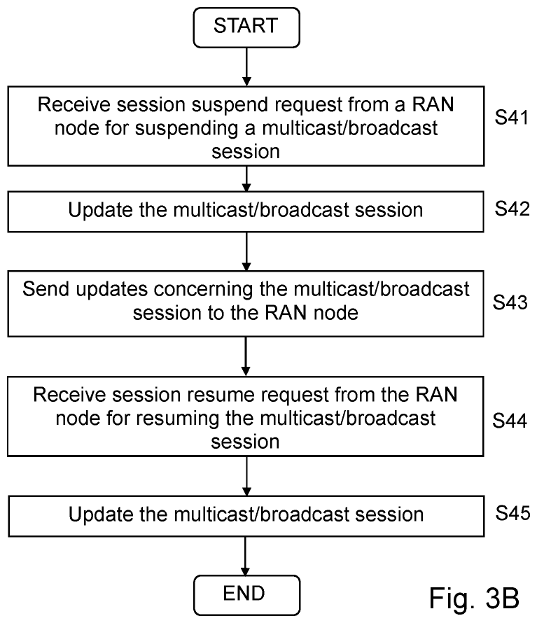

In particular, by referring to FIG. 4, an example for the first embodiment, option 1 is described, namely blind try and failure triggered by AMF for the pre-empted session case. It is noted gNB1 represents an example for a RAN node, which has to pre-empt an MBS session due to congestion.

Process 1: gNB1 suffers from congestion and decides to pre-empt an MBS session, as shown in A1. It sends NG Broadcast Release required, as shown in A2. Upon receiving the NG Broadcast release required message, the AMF sends an NG Broadcast release request message, as shown in A3. Upon receiving the NG Broadcast release response message from gNB1, the AMF generates the Namf_MBSBroadcast__ContextStatusNotify request to inform MB-SMF of the release of gNB1, as shown in A4. This message contains NG Broadcast release response transfer.

Process 2: At expiry of an internal timer, the AMF newly looks if gNB1 is still in the service area, as per the latest service area informed from MB-SMF, as shown in A5. If gNB1 is still in the service area, AMF tries again sending NG Broadcast setup request, as shown in A6. In this example for process 2 the gNB1 may still be in congestion situation and the admission control fails, as shown in A7. Thus, the gNB1 sends a Broadcast setup failure message to the AMF in A8.

Process 3: Later on, at expiry of an internal timer, the AMF newly looks again if gNB1 is still in the service area, as per the latest service area informed from MB-SMF, as shown in A9. If gNB1 is still in the service area, AMF tries again sending NG Broadcast setup request, as shown in A10. In this example for process 3 the gNB1 is no more in congestion situation and the admission control succeeds, as shown in A11. The broadcast session starts again in gNB1. The gNB1 sends the NG Broadcast session setup response message to inform AMF of the success, as shown in A12. The AMF relays the information by sending an Namf_MBSBroadcast_ContextStatsuNotify request message including NG Broadcast setup response transfer towards the MB-SMF, as shown in A13.

As mentioned above, an illustration of the same first embodiment, option 1 for the “failed session setup” case can be easily deduced by replacing the “NG broadcast release required” in the above call flow by “NG broadcast setup failure”.

### Second Embodiment

In the following, a second embodiment, according to which RAN timer handling by AMF is described. In the following, mainly the differences with respect to the first embodiment are described.

In the following, the case of a pre-empted session is described, namely that the RAN node pre-empts a broadcast session due to lack of resources and sends broadcast release required to AMF to notify the release.

### Ran Node:

The RAN node newly includes a new “wait timer before retry” IE to the NG broadcast release required message or NG broadcast release response message to indicate an estimation related to congestion period, within which it is useless for the 5GC to try restoring the broadcast session. In the following, the “wait timer before retry” is also referred to as “wait timer” only. It can also be referred to as “wait time” or “wait time before retry”.

If the RAN node receives a new broadcast session setup after timer expiry, the RAN node performs again admission control. If congestion has disappeared it may accept the broadcast session and allocate radio resources. In that case it replies to the AMF with NG broadcast setup response including an N2 container to notify the MB-SMF.

### AMF Node:

When the AMF receives the NG broadcast release required or NG broadcast release response message including the “wait timer before retry” for a given broadcast session the AMF stores the wait timer, then:

1/If the AMF broadcast session is updated during the timer duration, the AMF stores the updated N2 container and updated service area, if any. The AMF will not try to restore the broadcast session in the RAN node until expiry of the wait timer it received from the RAN node.

2/At wait timer expiry, if the RAN node is still within the service area of the MBS session, the AMF may re-send the NG broadcast session setup including the latest N2 container received from the MB-SMF for this broadcast session since the broadcast release required/response was received, i.e., during the timer duration.

It is noted that, if the RAN node is no longer in the service area of the MBS session, the AMF does not try to restore the broadcast session in this RAN node.

As mentioned above in connection with the first embodiment, in a failed setup session case, the RAN node fails the broadcast session setup due to lack of resources.

The handling for this failed session setup case can be deduced from the pre-empted session case by replacing the “NG broadcast Release Required” by “NG broadcast session setup failure”.

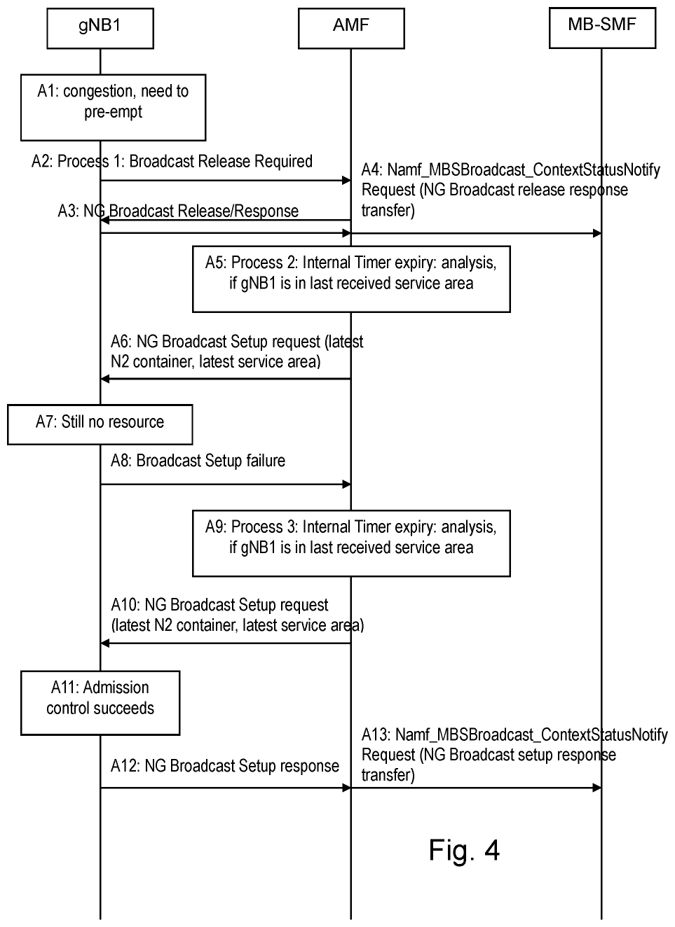

In the following, the second embodiment is described in more detail by referring to FIG. 5. Similar as in case of the first embodiment, gNB1 is an example for a RAN node which needs to pre-empt an MBS session. In particular, the example of RAN timer handling by AMF in the pre-empted session case is described.

Process 1: gNB1 suffers from congestion and decides to pre-empt an MBS session, as shown in B1. It sends NG Broadcast release required message, which includes the “wait timer before retry”, as shown in B2.

Process 2: Upon receiving the NG Broadcast release required message, the AMF stores the wait timer and sends an NG Broadcast release request message, as shown in B3.

Upon receiving the NG Broadcast release response message from gNB1, the AMF generates the Namf_MBSBroadcast__ContextStatusNotify request to inform MB-SMF of MBS session pre-emption/release in gNB1, as shown in B4.

Process 3: during the wait timer, the AMF receives a request from MB-SMF to update the MBS session, as shown in B5. The AMF stores the received N2 container and service area. The AMF however newly takes no action towards gNB1 even if involved in these modification as long as the wait timer is running, as shown in B6.

Process 4: at wait timer expiry, the AMF analyses the latest stored service area, as shown in B7. If gNB1 is involved, the AMF generates an NG Broadcast Setup message towards the gNB1, as shown in B8. The gNB1 runs admission control, as shown in B9.

Then, gNB1 sends the NG Broadcast session setup response message to inform AMF of the success, as shown in B10, and the AMF relays the information by sending an Namf_MBSBroadcast_ContextStatsuNotify request message including NG Broadcast setup response transfer towards the MB-SMF, as shown in B11.

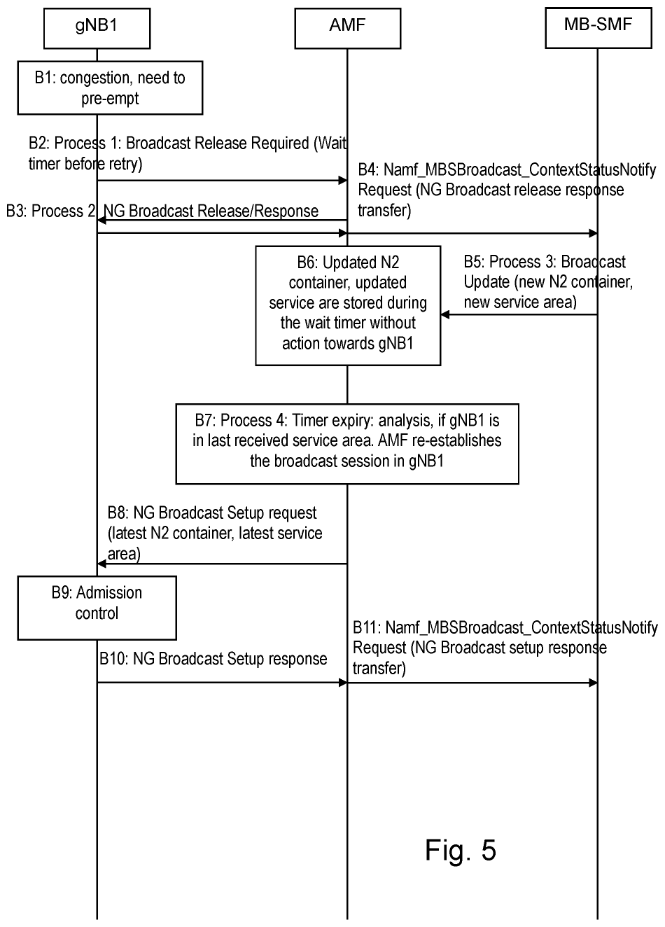

An example of the second embodiment of RAN timer handling by AMF in the failed session setup case is illustrated in FIG. 6. As explained above, an illustration of the same second embodiment for the “failed setup” case can be easily deduced by replacing the “NG broadcast release required” in the above call flow by “NG broadcast setup failure”, as shown in FIG. 6.

In particular, in process 1, the gNB1 receives the NG Broadcast set up request message from the AMF, as shown in C1. However, the gNB1 experiences congestion, so that it cannot allocate the necessary resources for the MBS session, as shown in C2. Hence, in process 2, the gNB1 sends a Broadcast setup failure message to the AMF, which contains the “wait timer before retry”, as shown in C3. The remaining procedure is then similar as shown in FIG. 5. That is, C4 to C11 correspond to B4 to B11 shown in FIG. 4.

### Third Embodiment

In the following, a third embodiment is described, according to which RAN timer handling is performed by the MB-SMF. In the following, mainly the differences with respect to the second embodiment are described.

At first, the case of a pre-empted session is described, in which a RAN node pre-empts a broadcast session due to lack of resources and sends broadcast release required to notify AMF of the request to release the MBS session.

The RAN node sends the NG broadcast release required message followed by NG broadcast release response message to AMF. The RAN node newly includes the “wait timer before retry” timer for a given broadcast session to inform the AMF.

The MB-SMF is also informed by one of these two options:

Option 1: when receiving the “wait timer before retry” timer from the RAN node, the AMF sends a Namf_MBSBroadcast ContextStatusNotify request message to MB-SMF including the RAN Node ID, an indication that the MBS session has been pre-empted by the NG RAN Node and the timer (the indication may be signaled implicitly by the presence of the timer).

Option 2: the RAN node also includes the “wait timer before retry” timer to the NG Broadcast Release Response Transfer IE which is relayed to the MB-SMF by the AMF within the Namf_MBSBroadcast ContextStatusNotify request message.

Upon receiving the Namf_MBSBroadcast__ContextStatusNotify request message from AMF, the MB-SMF stores the RAN node ID and associated wait timer before retry.

At RAN timer expiry in the MB-SMF the MB-SMF sends Broadcast Session update message (or start message if the MBS session had been terminated in all NG-RAN nodes) including the RAN node ID to AMF and the latest N2 container and latest service area. Upon receiving this Broadcast session update message (or start message) the AMF analyses the service area. If the RAN node ID is included in the service area, the AMF sends the NGAP Broadcast session setup message to the RAN node including the N2 container.

Also according to the third embodiment, a failed setup session case is possible, in which the RAN node fails the broadcast session setup due to lack of resources.

The handling for this failed setup session case can be deduced from the pre-empted session case by replacing the messages used by RAN to notify the CN:

For option 1, “NG broadcast Release Required” is replaced by “NG broadcast session setup failure”.

For option 2, “NG broadcast release response transfer” replaced by “NG broadcast setup failure transfer”.

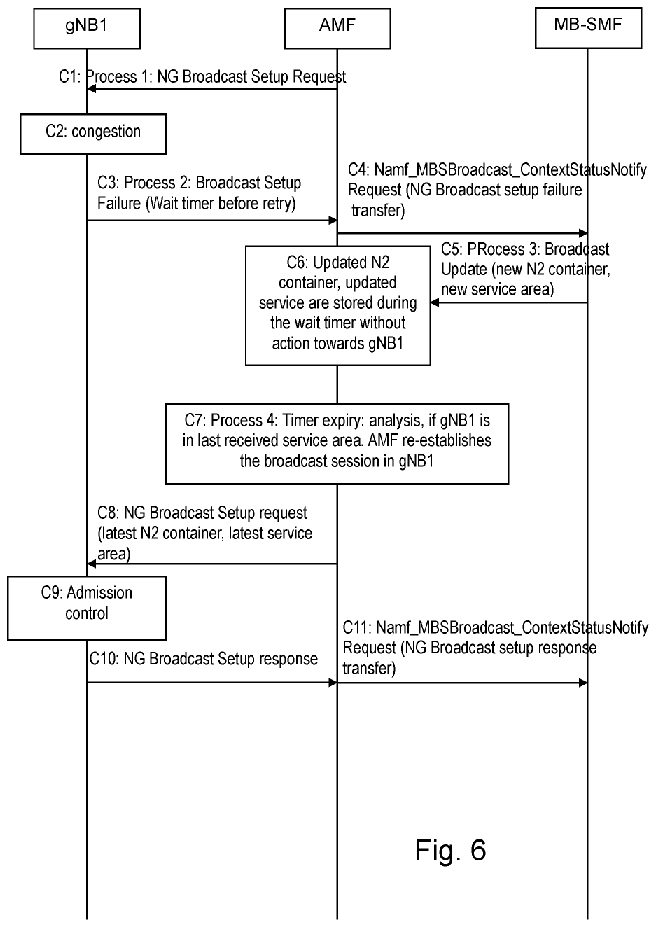

In the following, an example for the third embodiment, according to which the RAN timer handling is performed by the MB-SMF, is described in more detail by referring to a flow chart shown in FIG. 7. In this example, the pre-empted session case is described, and the option 1 described above is applied, i.e., the AMF relays the “wait timer before retry” to the MB-SMF.

Process 1: gNB1 suffers from congestion and decides to pre-empt an MBS session, as shown in D1. It sends NG Broadcast release required message, which newly includes the “wait timer before retry”, as shown in D2.

Process 2: Upon receiving the NG Broadcast release required message, the AMF sends an NG Broadcast release request message. Upon receiving the NG Broadcast release response message from gNB1, as shown in D3, the AMF generates the Namf_MBSBroadcast__ContextStatusNotify request to inform MB-SMF of gNB1 release, newly including the “wait timer before retry” towards the MB-SMF, as shown in D4.

Process 3: during the wait timer, the AMF receives a request from MB-SMF to update the MBS session, as shown in D5. The AMF stores the received N2 container and service area. The AMF however newly takes no action towards gNB1 even if involved in these modification as long as the wait timer is running, as shown in D6.

Process 4: at wait timer expiry, as shown in D7, the MB-SMF newly generates towards AMF a broadcast session update (or start) message including gNB1 as target, as shown in D8. Upon receiving the Broadcast Start including gNB1, the AMF analyses if gNB1 is involved in the service area, as shown in D9. If gNB1 is involved, the AMF generates an NG Broadcast setup message towards gNB1, as shown in D10. Thereafter, the gNB1 runs admission control, as shown in D11. The following procedure is similar to that described above, i.e., D12 and D13 correspond to C10 and C11, respectively.

In the following, a further example of the third embodiment is described, namely a failed session set up case, while RAN timer handling is performed by the by MB-SMF and option 1 is applied.

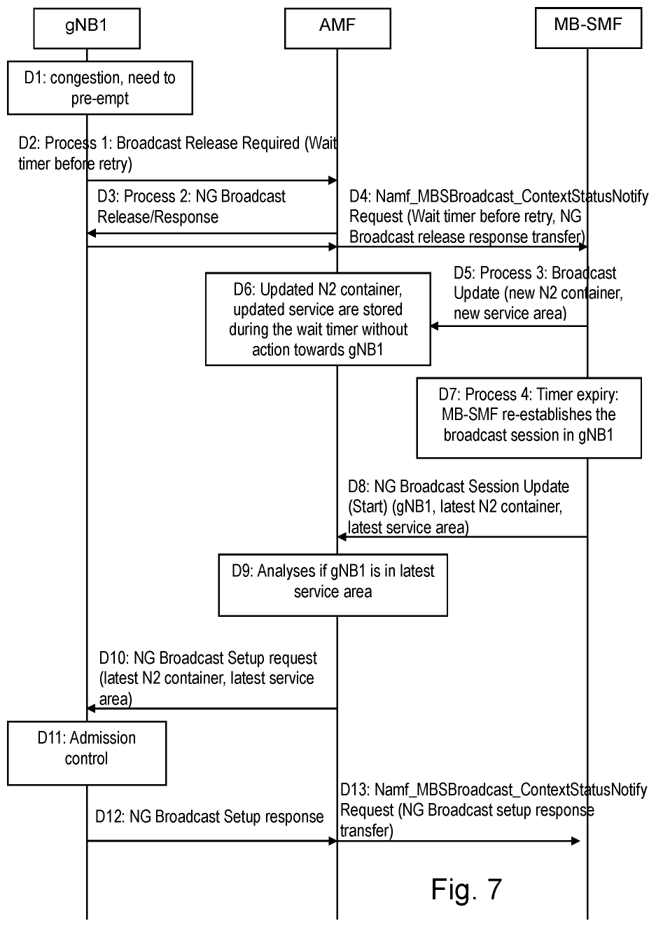

As explained above, an illustration of the same third embodiment for the “failed setup” case can be easily deduced by replacing the “NG broadcast release required” in the above call flow by “NG broadcast setup failure”, as illustrated in the flow chart shown in FIG. 8.

In particular, in process 1, the gNB receives the NG Broadcast set up request message from the AMF, as shown in E1. However, the gNB1 experiences congestion, so that it cannot allocate the necessary resources for the MBS session, as shown in E2. Hence, in process 2, the gNB sends a Broadcast setup failure message to the AMF, which contains the “wait timer before retry”, as shown in E3. Thereafter, the AMF sends the Namf_MBSBroadcast__ContextStatusNotify request including the “wait timer before retry” to the MB-SMF, as shown in E4.

The remaining procedure is then similar as shown in FIG. 7. That is, E5 to E13 correspond to D5 to D13, respectively.

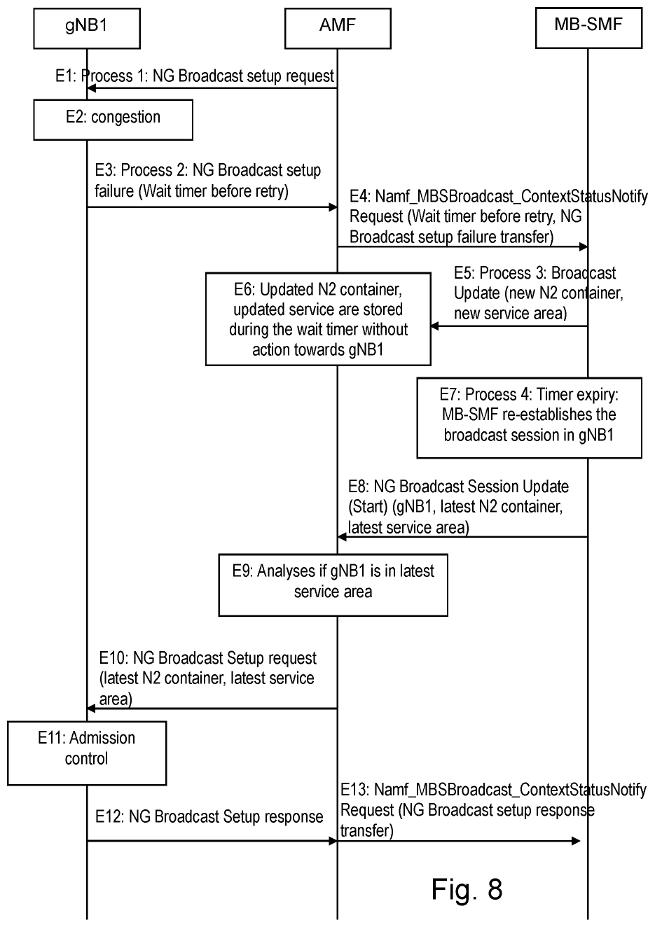

In the following, another example of the third embodiment is described, namely a pre-empted session case is described, while RAN timer handling is performed by the by MB-SMF, but option 2 is applied. This is described in the following by referring to the flow chart shown in FIG. 9.

Process 1: gNB1 suffers from congestion and decides to pre-empt an MBS session, as shown in F1. It sends NG Broadcast release required newly including the “wait timer before retry”, as shown in F2.

Process 2: Upon receiving the NG Broadcast release required message, the AMF sends an NG Broadcast release request message. gNB1 generates the NG broadcast release response message newly including the wait timer before retry inside the Broadcast release response transfer information element. Upon receiving the NG Broadcast release response message from gNB1, as shown in F3, the AMF generates the N_mbsmf_update_notify to inform MB-SMF of gNB1 release, wherein this message includes the NG Broadcast release response transfer, which in turn includes the wait timer included by the gNB1, i.e., the “Wait timer before retry”, as shown in F4. The MB-SMF newly stores the wait timer before retry associated with gNB1 received in the N2 container.

Process 3: during the wait timer, the AMF receives a request from MB-SMF to update the MBS session, as shown in F5. The AMF stores the received N2 container and service area. The AMF however newly takes no action towards gNB1 even if involved in these modification as long as the wait timer is running, as shown in F6.

Process 4: at wait timer expiry, the MB-SMF newly generates towards AMF a broadcast session update (or broadcast session start) message including gNB1 as target, as shown in F8. Upon receiving the Broadcast session Update (or start) including gNB1, the AMF analyses if gNB1 is involved in the service area, as shown in F9. If gNB1 is involved, the AMF generates an NG Broadcast setup message towards gNB1, as shown in F10. Thereafter, the gNB1 runs admission control, as shown in F11.

The remaining procedure is then similar as shown in FIG. 8; that is, F12 and F13 correspond to E12 and E13, respectively.

In the following, a fourth embodiment is described, according to which Suspending and Resuming the broadcast session at MB-SMF in the pre-empted session case is carried out The RAN (RAN node, e.g., gNB) suspends the MBS broadcast session and
a) if multicast N3mb is used, the RAN leaves the transport network multicast (e.g. IGMP leave). The RAN node suspends broadcast MRB(s) by updating MCCH; or
b) if unicast N3mb is used, the RAN sends Broadcast Session Suspend Request to the MB-SMF via the AMF. The MB-SMF updates the N4 session towards the MB-UPF to remove the DL Tunnel. The RAN nodes suspends broadcast MRB(s) by updating MCCH.

While the MBS broadcast session is suspended, the MB-SMF sends updates to the RAN node as usual, e.g. updating the MBS service area by adding/removing cells.

When resources become available again for the MBS broadcast session, the RAN performs the following:
a) If multicast N3mb is used, the RAN joins the transport network multicast (e.g. IMGP join). The RAN resumes broadcast MBR(s) by updating MCCH and starts broadcasting MTCH.
b) If unicast N3mb is used, the RAN sends Broadcast Session Resume Request to the MB-SMF via the AMF including N3mb DL Tunnel Info. The MB-SMF updates the N4 session adding the DL tunnel at the MB-UPF. The MB-SMF responses to the request (i.e. class 1 procedures on NGAP). The RAN resumes broadcast MBR(s) by updating MCCH and starts broadcasting MTCH.

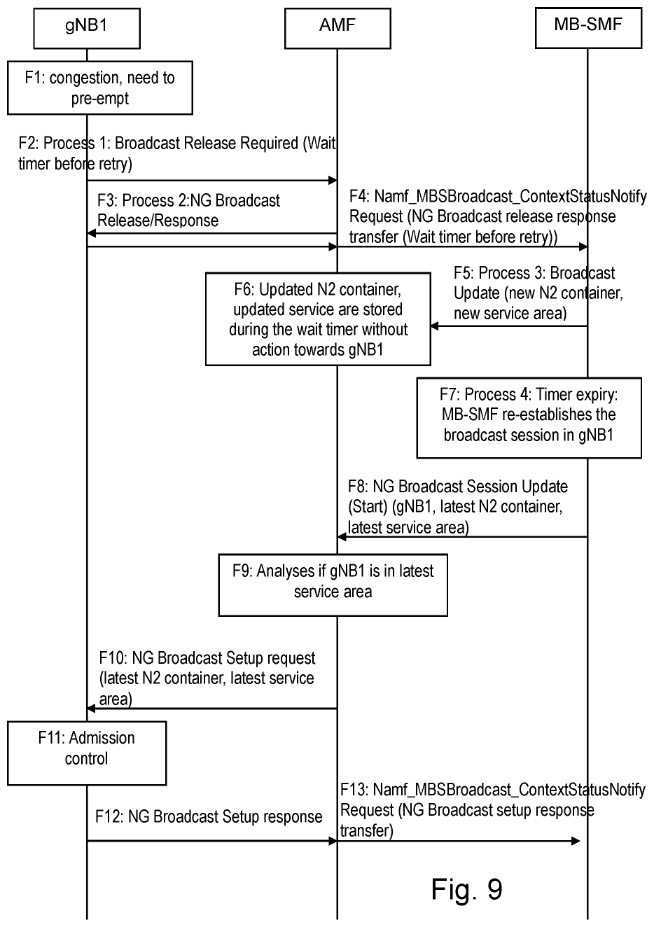

A more detailed example of the fourth embodiment, in which suspending and resuming the broadcast session at the MB-SMF is carried out is described in the following by referring to a pre-empted session case. In particular, an implementation of the fourth embodiment when multicast N3mb is used is shown in FIG. 10.

G1: The gNB experiences congestion and it needs to pre-empt a lower priority MBS broadcast session.

G2: The gNB suspends the MBS broadcast session. The configuration for the reception of MBS broadcast session is removed from the content of MCCH message and the updated MCCH is broadcast. In case there is no other MBS broadcast session in a cell, the gNB may stop broadcasting MCCH altogether in that cell.

G3: The gNB leaves the multicast group used in the transport network on the N3mb interface between the gNB and the MB-UPF.

G4 and G5: When radio resources become available in at least one cell of MBS session again, the gNB resumes the MBS broadcast session by adding the configuration for the reception of the MBS broadcast session to the MCCH and broadcasting the updated MCCH.

G6: The gNB joins the multicast group on the N3mb interface again.

G7: User data is transmitted in the MBS broadcast session.

It is noted that the suspension of MBMS session locally by eNB is possible in LTE but LTE does not specify that the eNB shall leave the multicast group on M1 interface. This means that the eNB still receives data for the MBMS session but the data is dropped and not broadcast.

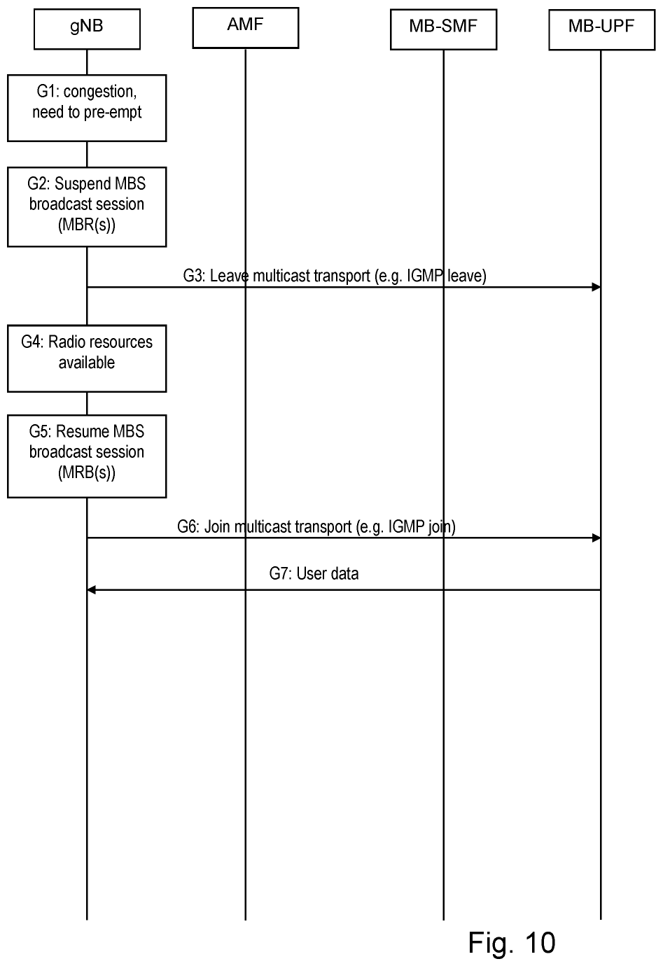

An implementation of the fourth embodiment when unicast transport over N3mb is used is shown in FIG. 11.

H1: The gNB experiences congestion and it needs to pre-empt a lower priority MBS broadcast session.

H2: The gNB suspends the MBS broadcast session. The configuration for the reception of MBS broadcast session is removed from the content of MCCH message and the updated MCCH is broadcast. In case there is no other MBS broadcast session in a cell, the gNB may stop broadcasting MCCH altogether in that cell.

H3: The gNB sends NGAP Broadcast Suspend Request (Note: NGAP Broadcast Release Required message with a flag indicating that the session is not released by the gNB but only suspended could be considered as an alternative.) to the AMF indicating the MBS Session ID of the suspended MBS broadcast session. It may be possible to suspend only some QoS flows and not the entire MBS session by including one or more QFIs of the suspended QoS flows. The gNB should include the downlink tunnel information (i.e. DL TNL Info) of the unicast N3mb tunnel, which is used by the MB-SMF and the MB-UPF to update N4mb session to either completely release the tunnel or modify the forwarding actions for this tunnel (i.e. suspended QoS flows are not forwarded). Alternatively, the MB-SMF can identify the correct N3mb tunnel from the RAN ID provided by the AMF in the notification, see process 4.

H4: The AMF notifies the MB-SMF and forwards the NGAP Broadcast Suspend Request. The AMF includes the identifier of the gNB (i.e. RAN ID) in the message to the MB-SMF.

H5: The MB-SMF updates the N4mb session at the MB-UPF instructing the MB-UPF to release the unicast N3mb tunnel, if the MBS broadcast session is suspended completely, or to stop forwarding data for the suspended QoS flows.

H6: The MB-UPF updates the N4mb session.

H7: The AMF replies with NGAP Broadcast Suspend Response.

H8 and H9: When radio resources become available in at least one cell of MBS session again, the gNB resumes the MBS broadcast session by adding the configuration for the reception of the MBS broadcast session to the MCCH and broadcasting the updated MCCH.

H10: The gNB sends NGAP Broadcast Resume Request to the AMF indicating the MBS Session ID of the resumed MBS broadcast session. The gNB may resume only some QoS flows. In this case, the request shall include one or more QFIs of the resumed QoS flows. The gNB shall include the DL TNL Info if the MBS broadcast session was suspended completely or if the gNB wants to change DL TNL Info as part of the resume procedure.

H11: The AMF notifies the MB-SMF and forwards the NGAP Broadcast Resume Request. The AMF includes the identifier of the gNB (i.e. RAN ID) in the message to the MB-SMF and forward the received DL TNL info to MB-SMF for the tunnel to be restored at MB-UPF.

H12: The MB-SMF updates the N4mb session at the MB-UPF instructing the MB-UPF to establish the unicast N3mb tunnel, if the MBS broadcast session was suspended completely, or to start forwarding data for the previously suspended QoS flows.

H13: The MB-UPF updates the N4mb session, and starts transmitting QoS flows or establishes the N3mB tunnel.

H14: The AMF replies with NGAP Broadcast Resume Response.

H15: User data is transmitted in the MBS broadcast session.

Thus, according to the above-described example embodiments it is possible for a RAN node or a similar element to join a MBS session even when the RAN node has to pre-empt resources during the MBS session or is not able to start the MBS session since it cannot allocate resources for the MBS session.

The above-described example embodiments are only examples and may be modified.

For example, according to some embodiments described above, specific messages such as a Namf_MBSBroadcast__ContextStatusNotify request sent from the AMF to the MB-SMF are described. However, other suitable messages are applicable as well, in which the new parameter such as the “wait timer before retry” can be sent from the RAN node to the AMF and/or from AMF to MB-SMF.

Moreover, the parameter “wait timer before retry” is an example only. For example, for this wait timer, also an existing value can be used, for example “Time To Wait” IE as specified in TR 38.413.

In the following, an embodiment is described in which an impact of TR 38.413 is illustrated.

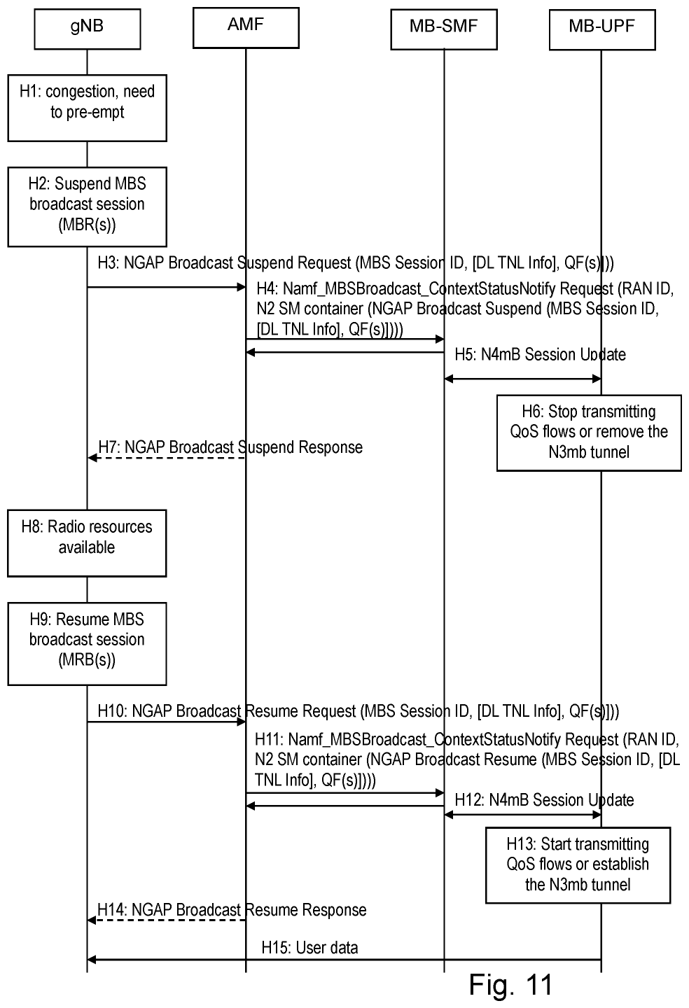

FIG. 12 shows an example for a broadcast session setup, unsuccessful operation.

The AMF sends a BROADCAST SESSION SETUP REQUEST in I1 in order to request the NG-RAN node to setup a broadcast session by providing resources.

If the NG-RAN node is not able to provide the resources for all the flows in the MBS session in any of its cells, it shall send the BROADCAST SESSION SETUP FAILURE message, as shown in I2.

If the BROADCAST SESSION SETUP FAILURE message includes the Time to Wait IE (or wait timer before retry), the AMF node shall wait at least for the indicated time before reinitiating the Broadcast Session Setup procedure towards the same NG-RAN node.

FIG. 13 shows a case of Broadcast Session Release Required, successful operation.

The NG-RAN node initiates the procedure by sending a BROADCAST SESSION RELEASE REQUIRED message to the AMF, as shown in J.

Upon reception of the BROADCAST SESSION RELEASE REQUIRED message, the AMF shall realize there is no adequate resources for NG-RAN node to provide the broadcast service over radio and start to release the MBS context corresponding to the previously established MBS session. If the BROADCAST SESSION RELEASE REQUIRED message includes the Time to Wait IE (or wait timer before retry), the AMF node shall wait at least for the indicated time before reinitiating the Broadcast Session Setup procedure towards the same NG-RAN node.

Names of network elements, protocols, and methods are based on current standards. In other versions or other technologies, the names of these network elements and/or protocols and/or methods may be different, as long as they provide a corresponding functionality.

In general, the example embodiments may be implemented by computer software stored in the memory (memory resources, memory circuitry) 12, 22 and executable by the processor (processing resources, processing circuitry) 11, 21 or by hardware, or by a combination of software and/or firmware and hardware.

As used in this application, the term “circuitry” refers to all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The memory (memory resources, memory circuitry) 12, 22 may be of any type suitable to the local technical environment and may be implemented using any suitable data storage technology, such as semiconductor based memory devices, magnetic memory devices and systems, optical memory devices and systems, fixed memory and removable memory, and non-transitory computer-readable media. The processor (processing resources, processing circuitry) 11, 21 may be of any type suitable to the local technical environment, and may include one or more of general purpose computers, special purpose computers, microprocessors, digital signal processors (DSPs) and processors based on a multi core processor architecture, as non-limiting examples.

It is to be understood that the above description is illustrative of the invention and is not to be construed as limiting the invention. Various modifications and applications may occur to those skilled in the art without departing from the true spirit and scope of the invention as defined by the appended claims.

1. A multicast/broadcast control element, comprising:
at least one processor and at least one memory including computer program code, the computer program code configured to, when executed by the at least one processor, cause the apparatus at least to perform:
sending, to at least one radio access network node, a request for allocating resources for a multicast/broadcast session;
receiving, from at least one radio access network node, an error message indicating that the resources cannot be allocated or cannot be maintained for the multicast/broadcast session; and
re-sending a request for allocating resources for the multicast/broadcast session to the at least one radio access network node having sent the error message after elapse of a predetermined time.

2. The multicast/broadcast control element according to claim 1, wherein the predetermined time is preset by an internal timer of the apparatus.

3. The multicast/broadcast control element according to claim 1, wherein the at least one memory and the computer program code are configured to, with the at least one processor, cause the apparatus to further perform:
storing information concerning the multicast/broadcast session.

4. The multicast/broadcast control element according to claim 1, wherein the at least one memory and the computer program code are configured to, with the at least one processor, cause the apparatus to further perform:
storing any update received of the previously stored information concerning the multicast/broadcast session, and
using the latest updated information for resending retrying to initiate the multicast/broadcast session after elapse of the predetermined time.

5. The multicast/broadcast control element according to claim 4, wherein the at least one memory and the computer program code are configured to, with the at least one processor, cause the apparatus to further perform:
receiving information concerning the multicast/broadcast session from a multicast broadcast session management function.

6. The multicast/broadcast control element according to, wherein the computer program code is configured to, when executed by the at least one processor, cause the apparatus to further perform:
before re-sending the request for allocating resources for the multicast/broadcast session to the at least one radio access network node, determining whether the least one radio access network node is in a service area specified for the multicast/broadcast session.

7. An apparatus for a radio access network, comprising:
at least one processor and at least one memory including computer program code, the computer program code configured to, when executed by the at least one processor, cause the apparatus at least to perform:
receiving a request for allocating resources for a multicast/broadcast session from a multicast/broadcast control element,
when resources cannot be allocated for the multicast/broadcast session or resources have to be released during the multicast/broadcast session, sending, to the multicast/broadcast control element, an error message indicating that the resources cannot be allocated or cannot be maintained, and
in response to receiving a further request for allocating resources for the multicast/broadcast session, re-trying to allocate resources for multicast/broadcast session.

8. A method for a multicast/broadcast control element, comprising:
sending a request for allocating resources for the multicast/broadcast session to at least one radio access network node,
receiving, from at least one radio access network node, an error message indicating that the resources cannot be allocated or cannot be maintained, and
re-sending a request for allocating resources for the multicast/broadcast session to the at least one radio access network node having sent the error message after elapse of a predetermined time.

9. The method according to claim 8, wherein the predetermined time is preset by an internal timer of the multicast/broadcast control element.

10. The method according to claim 8, further comprising:
storing information concerning the multicast/broadcast session.

11. The method according to claim 10, further comprising:
storing any update received of the previously stored information concerning the multicast/broadcast session, and
using the latest updated information for resending retrying to initiate the multicast/broadcast session after elapse of the predetermined time.

12. The method according to claim 11, wherein the method further comprises:
receiving information concerning the multicast/broadcast session from a multicast broadcast session management function.

13. The method according to claim 8, further comprising:
before re-sending the request for allocating resources for the multicast/broadcast session to the at least one radio access network node, determining whether the least one radio access network node is in a service area specified for the multicast/broadcast session.

14-17. (canceled)
